(19) United States
(12) Patent Application Publication
(10) Pub. No.: US 2017/0149980 A1
(43) Pub. Date: May 25, 2017

(54) FACILITATING A CONFERENCE CALL

(71) Applicant: VODAFONE IP LICENSING LIMITED, London (GB)

(72) Inventor: Martin ABERG, London (GB)

(21) Appl. No.: 15/316,334

(22) PCT Filed: Jun. 4, 2015
(86) PCT No.: PCT/EP2015/062492

§ 371 Date: Dec. 5, 2016

(30) Foreign Application Priority Data
Jun. 5, 2014 (GB) 1409974.1

(51) Int. Cl. H04M 3/56; H04M 3/42

(52) U.S. Cl. CPC H04M 3/56; H04M 3/42348; H04M 2203/2094; H04M 2203/5063; H04M 2207/18; H04M 2242/30

(57) ABSTRACT

To facilitate a call between a user of a mobile device and a host of the call, a location of the mobile device is obtained. Based on the obtained location, a device identifier for a local device is automatically retrieved, wherein the local device is located at or around the obtained location. A dial-out request is sent to a conference system requesting that the conference system establish a communication link between the local device associated with the retrieved device identifier and a remote device associated with the host.

### BACKGROUND

A conference call is a call where more than two participants are involved. Typically a conference call is arranged as a series of communication links, each link being between a host and a participant. These are often enabled by means of a prior art conference system, such as a conference bridge.

In use, a user wishing to join a conference call is provided with a telephone number for the conference system and a conference PIN identifying the particular conference call. The user then calls the telephone number using a local device (such as a speakerphone), and provides the conference PIN. The conference system then connects the local device to a remote device associated with the host.

The prior art procedure generally involves a great deal of manual data entry. In particular, the user must enter the telephone number for the conference system manually, then enter the conference PIN. This is required at the beginning of every conference call.

It would therefore be desirable to provide a system and a method for facilitating a call between a user and a host which avoids (or at least reduces) the manual data entry required by prior art methods.

### SUMMARY OF INVENTION

In a first aspect, there is provided a method for facilitating a call between a user of a mobile device and a host of the call. A location of the mobile device is first obtained. A device identifier for a local device is then automatically retrieved, based on the obtained location. In particular, the local device is located at or around the obtained location. A dial-out request is then sent to a conference system requesting that the conference system establish a communication link between the local device associated with the retrieved device identifier and a remote device associated with the host. In this manner, the amount of manual data entry required by the user is limited. Instead, the method relies on using a local device which is already associated with the location of the user or the user's device. Thus the method provides a much more efficient means for facilitating a call between the user and the host, and reduces the risk of errors that can occur when data is manually entered.

Automatically retrieving the device identifier for the local device based on the retrieved location may comprise selecting a local device at or proximate the obtained location and retrieving a device identifier associated with the selected local device. It can be envisioned that in some cases, a plurality of local devices are available. In such a case, it can be useful to select one of the devices, preferably the one nearest to the obtained location.

Obtaining the location of the mobile device may comprise querying a GPS module associated with the mobile device for the current location of the mobile device, and in response to the querying, receiving the current location from the GPS module. In this manner, an accurate location of the user's mobile device (and thus, by extension, the user) can be obtained, which in turn allows the local device nearest the user to be automatically selected with increased accuracy.

Additionally or alternatively, obtaining the location of the mobile device may comprise querying a calendar module associated with the user of the mobile device for the expected location of the user and in response to the querying, receiving the expected location from the calendar module. This may be of particular value where a current location is not available, for example when inside a building such that GPS cannot connect or when a location module is otherwise unavailable.

In preferred embodiments, the method further comprises retrieving conference information, the conference information identifying a conference system. Sending a dial-out request to the conference system comprises sending a dial-out request to the identified conference system. In this manner, a particular conference system can be specified when a plurality are available.

Retrieving the conference information may comprise receiving a user input identifying a conference from among a set of conferences and retrieving the conference information based on the identified conference. This may be of particular benefit where the user may have a large number of conferences available, and provides a mechanism by which the user can select the appropriate one.

In preferred embodiments, before sending a dial-out request, the user of the mobile device is prompted to confirm that the automatically retrieved device identifier is to be used for establishing the communication link. This can provide a final check that the automatically retrieved, obtained and inferred data is correct and suitable for use.

In preferred embodiments, in response to prompting the user, a negative response is received from the user. Subsequently, encoded data can be retrieved from a data medium located proximate a second local device; and the encoded data decoded to retrieve a second device identifier for the second local device. Sending a dial-out request to a conference system comprises sending a dial-out request to a conference system requesting that the conference system establish a communication link between the second local device associated with the second device identifier and the remote device associated with the host. Thus if the automatically retrieved, obtained and inferred data is incorrect, or the user desires an alternative local device, they can rely on a method which nevertheless avoids the need for much manual data entry. Instead, a data medium can be used to retrieve the device identifier for the alternative local device.

The data medium may comprise machine-readable indicia, such as a QR code, or may be associated with a proximity-based device, such as an NFC device or an ultrasound communication device.

In preferred embodiments, the method further comprises storing the second device identifier with the obtained location in a data store.

### BRIEF DESCRIPTION

The present invention will now be described with reference to the accompanying drawings, in which:

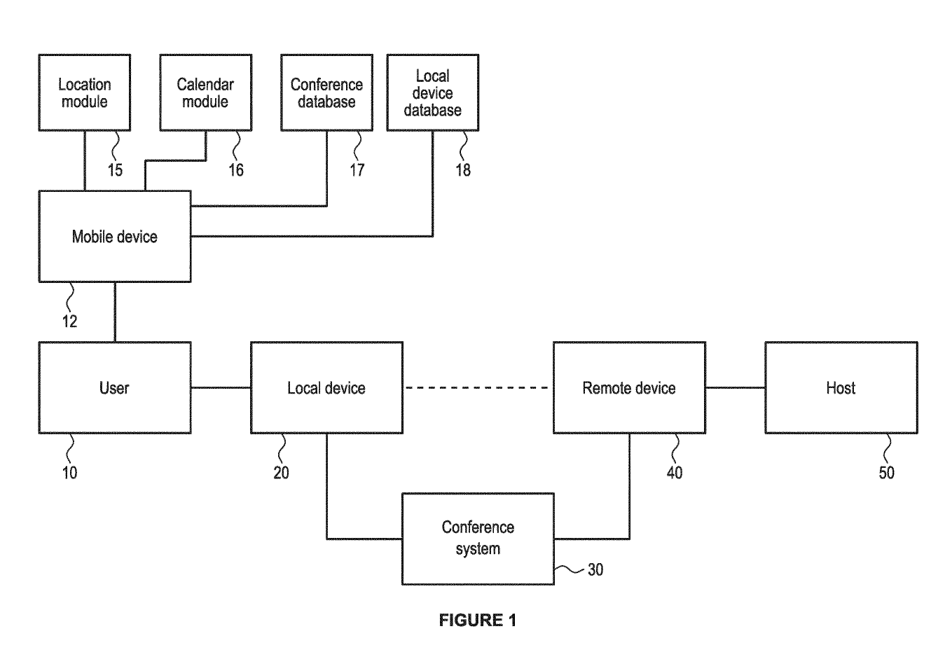

FIG. 1 shows a system according to an embodiment of the present invention;

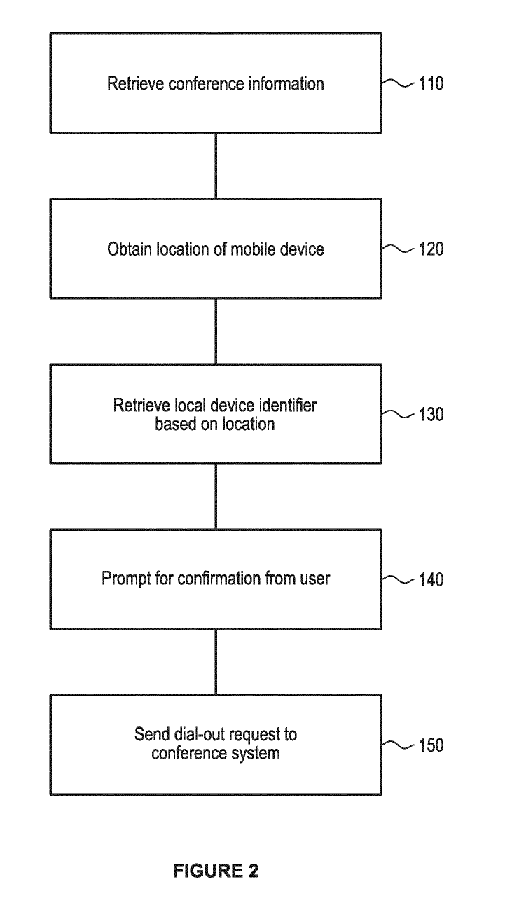

FIG. 2 shows a method of operation of the system of FIG. 1;

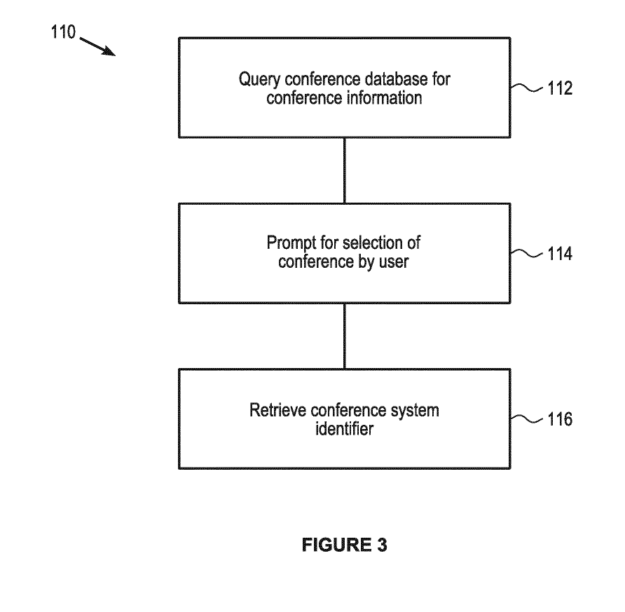

FIG. 3 shows an embodiment of step 110 of the method shown in FIG. 2;

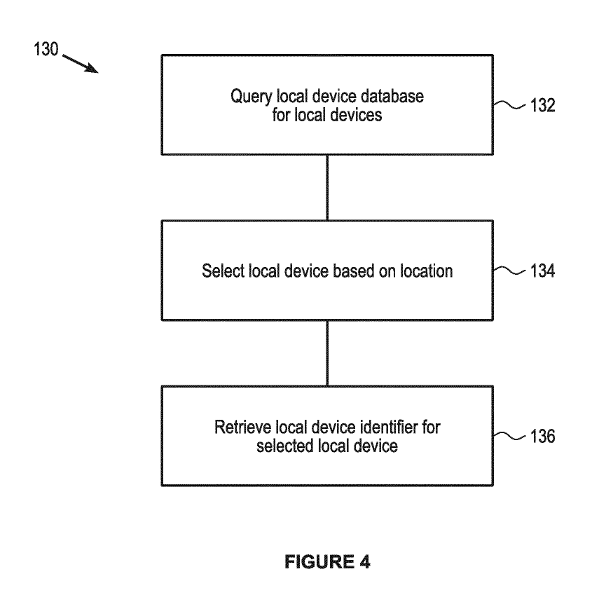

FIG. 4 shows an embodiment of step 130 of the method shown in FIG. 2; and

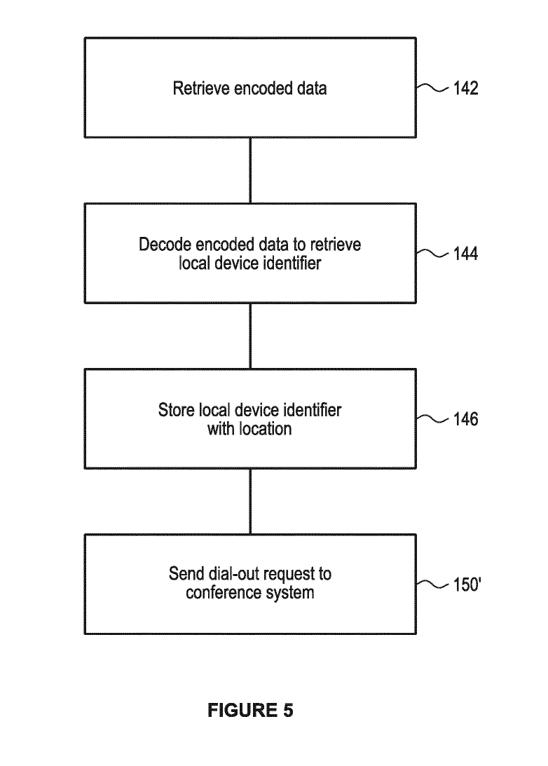

FIG. 5 shows a further step for use in an embodiment of the method of FIG. 2.

### DETAILED DESCRIPTION

FIG. 1 shows a system for facilitating a call between a user of a mobile device and a host of the call.

User 10 has an associated mobile device 12. The mobile device 12 may be a mobile phone, such as a smartphone.

The mobile device 12 comprises a location module 15 which is configured to calculate the current location of the mobile device. The location module 15 may be configured to use the Global Positioning System (GPS) in order to provide the current location of the mobile device as a set of coordinates.

The location module 15 may additionally or alternatively be configured to make use of one or more other kinds of location-sensitive devices or mechanisms, each of which provide data that can be used in calculating the location of the mobile device 12. In particular, these may include measurement devices, such as one or more compasses or accelerometers. These may additionally or alternatively include wireless infrastructure such as WiFi and/or GSM cells. One or more of these devices or mechanisms can be used either individually or in combination in calculating the location of the mobile device 12, but in preferred embodiments are used to supplement GPS measurements or the like. This may be of particular use when inside a building, where GPS may be unsuitable, due to reduced accuracy or unavailability. Moreover, the calculated location may be combined with a building map or the like to calculate where in a building the user is, such as by referencing a floor number and/or a room name.

In use, the location of the mobile device can be treated as equivalent to the location of the user, as in many cases the user will carry the mobile device on them at all times.

The mobile device 12 can be in communication with a calendar module 16. In some cases, the calendar module 16 may be local to the mobile device 12, for example as an application on the mobile device 12 with data stored in the memory of the mobile device 12.

The calendar module 16 comprises records of appointments and the like for the user. Each of these records may include location information indicating an expected location of the user at the time of the appointment. For example, the calendar module may have a record of an appointment occurring in “The Boardroom” at “11.30 to 12.30”. It can therefore be inferred that the user will be in the Boardroom at 11.30 to 12.30.

The mobile device 12 can be in communication with a conference database 17. The conference database 17 includes records of conferences scheduled to occur for the user and/or for the user's organisation. Each record typically includes a time, a date and information about the corresponding conference system (such as a phone number for the conference system and a conference PIN). In some embodiments, the function of the conference database 17 is fulfilled by the calendar module 16, such that each record of a conference is stored as an appointment for the user.

In practice, a user 10 may have access to a large number of local devices 20 for use in calling a remote host 50. In many cases, the local device 20 will be a conference phone or the like. However, it could alternatively be a conventional phone, an Internet-enabled computer or any other device which is suitable for connection with the host 50. Typically the term “local device” excludes the mobile device 12 of the user 10.

Each local device 20 has one or more local device identifiers associated with it. The number and type of local device identifier typically relates to the type of local device 20. For example, if the local device is a conventional telephone, the device identifier may be a telephone number. The local device identifiers are typically unique to the local device 20, such that one local device identifier always corresponds to the same local device 20. However, a local device 20 may have more than one local device identifier.

In practice, a local device is often located in a single location, and is generally non-mobile. This can be a geographical location or a location within a building.

Thus, the mobile device 12 may be in communication with a local device database 18. The local device database 18 includes entries mapping a local device (and a local device identifier) to the location of each local device 20.

A local device 20 may be provided with a data medium proximate the local device. The data medium can store one or more of the device identifiers associated with the local device 20. This is typically encoded in a machine-readable format. In some cases, the data medium could be included as part of a proximity-based device including a transmitter and/or a receiver which can be configured to communicate the one or more device identifiers to another suitably configured device.

In a preferred embodiment, the data medium may be a graphical indicia such as a Quick Response (QR) code, which can be scanned and decoded by the mobile device 12 (or at least by a camera or other scanner associated with the mobile device 20) to retrieve the device identifier.

In another preferred embodiment, the data medium could be associated with a near-field communication (NFC) device configured to communicate the data to a suitable receiver (such as an NFC receiving module associated with the mobile device 20) using NFC technology.

In a further preferred embodiment, the data medium could be associated with an ultrasound communication device configured to communicate the data to a suitable receiver (such as a transducer associated with the mobile device 20) using ultrasonic transmission (typically exceeding about 16 kHz or about 20 kHz). This may operate substantially automatically such that the mobile device 20 continuously or periodically queries for ultrasound communication devices located proximate the mobile device 20.

Each local device 20 is capable of communication with a conference system 30. The conference system 30 is provided to facilitate a call between a user 10 at the local device 20 and a host 50 at a remote device 40. The conference system 30 may comprise a conference bridge. The conference system 30 is generally located distant from both the local device 20 and the remote device 40.

In some cases, a plurality of conference systems may be available. Each conference system may be identified by a unique conference system identifier which can be used to forward requests to one of the conference systems to facilitate calls. Typically, a particular conference system is indicated by the host 50 for use in a call.

FIG. 2 shows a method for facilitating a call between a user 10 of a mobile device 12 and a host 50 of the call.

At step 110, conference information about the conference is retrieved, preferably from the conference database 17. The conference information includes at least a conference system identifier (such as a phone number for the conference system) which can be used in identifying and communicating with the conference system. It may also include a conference PIN for the conference, a date, a time, information about the participants, information about the host and the like. An preferred embodiment of step 110 is shown in FIG. 3.

At step 120, a location of the mobile device 12 is obtained. In preferred embodiments, the location is the current location of the mobile device 12, as calculated by the location module 15. Additionally or alternatively, where the calendar module 16 associated with the mobile device 12 has a relevant entry, the expected location of the user 10 at a given time can be retrieved from the calendar module 16. Generally, a current location from the location module 15 should be preferred over an expected location from the calendar module 16 where there is a conflict between the two.

At step 130, a device identifier for a local device is retrieved based on the obtained location. Typically it is retrieved from the local device database 18. This step can be automatically performed following step 120 without any user input or the like. A local device located at or around the obtained location can be determined, and the device identifier for this local device retrieved. For example, if the obtained location is “The Boardroom”, the local device may be a speakerphone located in the Boardroom and the device identifier can be the telephone number of the speakerphone. A preferred embodiment of retrieving a device identifier is explained below with reference to FIG. 4.

At step 140, the user is prompted to confirm that a communication link should be established between the local device 20 associated with the local device identifier and the remote device 40. Typically, the prompt will be shown on a display associated with the mobile device 12 by means of an appropriate graphical user interface. The graphical user interface displays sufficient information that the user can identify the local device 20 and the location of the local device 20. For example, the graphical user interface may show the local device identifier and the name of the room in which the local device is located.

The user is then provided a mechanism by which to provide a positive or a negative response, for example by means of graphical user interface buttons. A preferred embodiment of the steps performed following a negative response is explained below with reference to FIG. 4. Following a positive response by the user, the method then proceeds to step 150.

At step 150, a dial-out request is sent to a conference system. The dial-out request requests that the conference system establish a communication link between the local device 20 and a remote device associated with the host. In this manner, the call is then established between the user and the host. Typically the dial-out request specifies the local device identifier (such as a telephone number) and a conference identifier (such as a conference PIN).

FIG. 3 shows a preferred embodiment of retrieving conference information at step 110.

At step 112, the conference database 17 is queried for conferences related to the user 10 (for example, conferences which list the user 10 as an participant). This can be limited to conferences either underway at the time of the query or scheduled to occur in the near future (such as the 24 hours following the time of the query). Information about each of the conferences is then presented to the user. For example, the subject, participants, time and date may be presented in a suitable graphical user interface. For simplicity, information about the conference system 30 itself (such as the conference system identifier) may be omitted from the graphical user interface. The graphical user interface is also provided with a mechanism through which a user can select one of the conferences.

Subsequently, at step 114, a selection of a conference is received from the user via the graphical user interface.

At step 116, information about the conference system associated with the selected conference is retrieved. This can comprise a conference system identifier (such as a phone number) and a conference call identifier for the conference call (such as a conference PIN). In some embodiments, the information is stored in a suitable data store for subsequent use.

FIG. 4 shows a preferred embodiment of retrieving a local device identifier based on location information at step 130.

At step 132, the local device database 18 is queried for local devices. This may be limited based on access criteria, to avoid the selection of local devices which are unavailable to the user. For example, if a local device is in a restricted access room, it may be impossible for the user to make use of that device. Moreover, if a device is currently in use, it may be impossible to select that device.

At step 134, a local device 20 is selected from the results of the query based on the previously obtained location. In particular, if the obtained location matches the location of one of the entries of the local device database 18, the local device of that entry is selected.

If the obtained location does not match exactly any of the locations of the entries of the local device database 18, typically the local device having a location nearest to the obtained location is selected. The calculation of the nearest local device may be a simple straight line distance between the obtained location and the local device's location, or may be based on the travel distance between the two points. The latter may be particularly suitable in a building, where travelling between floors of a building may take longer than the direct vertical distance between the points would suggest.

Alternatively, the user may be prompted to select one of the local devices near the obtained location through a suitable graphical user interface display at mobile device 12.

At step 136, a local device identifier associated with the selected local device 20 is retrieved. The local device identifier may, for example, be a telephone number for the selected local device. Where a plurality of device identifiers are available, the “most preferred” device identifier (based on a predetermined order) may be selected. For example, a telephone number may be preferred over an IP address. Alternatively, a plurality of the device identifiers for the local device may be retrieved and presented to the user. The user can then select which is their most preferred.

FIG. 5 shows a preferred embodiment of the steps performed following a negative response at step 140. In the case of a negative response, it is assumed the user 10 will wish for an alternative local device to be used. To facilitate this, each local device available to the user is provided with a computer-readable data medium containing encoded data. The encoded data is formed by applying any suitable prior art method to the local device identifier associated with the local device. One such method comprises encoding the data as a QR code, as described in ISO 18004.

Thus at step 142, encoded data is retrieved from the data medium. This can be accomplished in a suitable manner depending on the nature of the data medium. For example, where the data medium is a visual indicia, the encoded data can be retrieved by scanning.

At step 144, the encoded data is decoded to retrieve the local device identifier. As will be appreciated, the method used for decoding the encoded data is based on the method used to encode the data originally, and can be selected on that basis.

At step 146, the local device identifier is stored in the local device database 18 together with the current location of the mobile device. This is generally the same as the location obtained at step 120.

Finally, at step 150′, a dial-out request is sent to the conference system. This is identical to step 150 described above, except that the local device identifier retrieved at step 144 is used. A call is thus then established between the user and the host.

Although the embodiments of FIGS. 3, 4 and 5 have been described separately, it will be appreciated that any of the embodiments may be implemented in isolation, or in combination with one or both of the other embodiments.

In use, the methods of FIGS. 2, 3, 4 and 5 may be performed by the mobile device 12, preferably by executing a suitably configured program or set of computer-executable instructions stored in a memory or computer-readable medium associated with the mobile device 12.

1. A method for facilitating a call between a user of a mobile device and a host of the call, the method comprising:
obtaining a location of the mobile device;
automatically retrieving, based on the obtained location, a device identifier for a local device, wherein the local device is located at or around the obtained location;
sending a dial-out request to a conference system requesting that the conference system establish a communication link between the local device associated with the retrieved device identifier and a remote device associated with the host.

2. The method of claim 1, wherein automatically retrieving the device identifier for the local device based on the retrieved location comprises:
selecting a local device at or proximate the obtained location;
and retrieving a device identifier associated with the selected local device.

3. The method of claim 1, wherein obtaining the location of the mobile device comprises: querying a GPS module associated with the mobile device for the current location of the mobile device; and in response to the querying, receiving the current location from the GPS module.

4. The method of claim 1, wherein obtaining the location of the mobile device comprises:
querying a calendar module associated with the user of the mobile device for the expected location of the user; and
in response to the querying, receiving the expected location from the calendar module.

5. The method of claim 1, further comprising:
retrieving conference information, the conference information identifying a conference system;
wherein sending a dial-out request to the conference system comprises sending a dial-out request to the identified conference system.

6. The method of claim 5, wherein retrieving the conference information comprises:
receiving a user input identifying a conference from among a set of conferences; and
retrieving the conference information based on the identified conference.

7. The method of claim 1, further comprising:
before sending a dial-out request, prompting the user of the mobile device to confirm that the automatically retrieved device identifier is to be used for establishing the communication link.

8. The method of claim 7, further comprising: in response to prompting the user,
receiving a negative response from the user; retrieving encoded data from a data medium located proximate a second local device; and
decoding the encoded data to retrieve a second device identifier for the second local device;
wherein sending a dial-out request to a conference system comprises sending a dial-out request to a conference system requesting that the conference system establish a communication link between the second local device associated with the second device identifier and the remote device associated with the host.

9. The method of claim 8, wherein the data medium comprises machine-readable indicia.

10. The method of claim 9, wherein the machine-readable indicia comprises a QR code.

11. The method of claim 8, wherein the data medium is associated with a proximity-based device.

12. The method of claim 11, wherein the proximity-based device comprises an NFC device.

13. The method of claim 11, wherein the proximity-based device comprises an ultrasound communication device.

14. The method of claim 8, further comprising: storing the second device identifier with the obtained location in a data store.

15. A mobile telephony device, comprising: a location obtaining module for obtaining a location of the mobile device; a telephony device identification module for automatically retrieving, based on the obtained location, a device identifier for a local device, wherein the local device is located at or around the obtained location; a dial-out request sending module for sending a dial-out request to a conference system requesting that the conference system establish a communication link between the local device associated with the retrieved device identifier and a remote device associated with the host.

16. A computer-readable medium having computer-executable instructions stored thereon which, when executed by a computer, cause the computer to perform the method of claim 1.
